(19) United States
(12) Patent Application Publication
(10) Pub. No.: US 2006/0174119 A1
(43) Pub. Date: Aug. 3, 2006

(54) Authenticating destinations of sensitive data in web browsing

(76) Inventor: Xin Xu, Palo Alto, CA (US)

Correspondence Address: PERKINS COIE LLP, P.O. BOX 2168, MENLO PARK, CA, 94026, US

(21) Appl. No.: 11/196,660

(22) Filed: Aug. 2, 2005

Related U.S. Application Data
(60) Provisional application No. 60/649,921, filed on Feb. 3, 2005.

(51) Int. Cl. H04L 9/00

(52) U.S. Cl. 713/170

(57) ABSTRACT

The present invention is described and illustrated in conjunction with systems, apparatuses and methods of varying scope. A method and apparatus for authenticating destinations of sensitive data in web browsing is described and illustrated. In an embodiment, the invention is a method. The method includes receiving website data from a website and displaying the website data. The method also includes receiving data for submission to the website, intercepting partial user input data, matching partial user input data against the set of web sites and associated sensitive data, if a defined match is found. The method also includes offering the user the option to complete the input by selecting from the set of sensitive data or continuing to type in the rest of input data, replacing input data with aliases, and passing only the aliases to the web page. Further, the method includes receiving a request to submit the data. Moreover, the method includes recognizing the data as appropriate for protection. Additionally, the method includes authenticating the website with a set of websites related to the data. The authenticating includes determining what set of websites corresponds to the data and comparing an IP address of the website to the set of websites. The method also includes restoring data from corresponding aliases when sending the data to an authenticated web site.

### CROSS-REFERENCE TO RELATED APPLICATION

This application claims priority to U.S. Provisional Application No. 60/649,921, filed Feb. 3, 2005, which is hereby incorporated by reference in its entirety.

### FIELD

The present application generally relates to surfing the web and more specifically relates to software-based verification of where information is sent during web-surfing.

### BACKGROUND

Modem consumers are increasingly relying on the Internet to conduct various everyday activities, such as online banking, online purchasing of services and goods, and online investing, for example. As consumer online activities increase dramatically, various online security attacks targeting consumers have also increased dramatically. One frequent online security attack is so-called “phishing” attacks, where someone sets up a fraudulent web site that is a look-alike to a legitimate web site (such as a web site of a bank for example), then misleads users to visit the fraudulent web site (such as through spoofed emails containing HTML links to the fraudulent web site). Once on the fraudulent web site, unsuspecting users are asked to enter their personal information, such as account login Id, and password, credit card number, or other similar information.

Online security attacks like “phishing” represent major threat to both business and individual consumers alike. They can cause significant financial damage to business and consumers, and erode the confidence of business and consumer users toward the Internet as a vital infrastructure in daily life.

Existing approaches to protect users from sending personal sensitive information to unintended receivers generally falls into the following categories:

Authenticating the email sender—avoiding “spoofed” or “forged” emails.

Compiling a list of known fraudulent websites, and preventing visits to such web sites.

Examining a web site for telltale signs of possible fraud, and, if the web site is suspicious, blocking such site in the browser.

Each of these methods is discussed further below.

Authenticating the email sender, and thus preventing “spoofed” emails is the most developed of the techniques. Today, many “phishing” attacks start with a “spoofed” email from the attacker. The proponents of the email authentication system argue that if email systems can determine the true identity of an email sender, then “phishing” attackers will not be able to pose as someone else, and thus “spoofed” email can be stopped before it reaches users.

There are several disadvantages of the email authentication approach. Currently, there are two incompatible and competing email authentication technologies; one is the “DomainKeys” technology proposed by Yahoo, Inc., the second one is the “Sender Id” technology proposed by Microsoft Inc. Both proposed email authentication technologies are fairly expensive, as each involves enhancing existing email systems. “Phishing” attackers are already adapting to the email authentication technologies. Recently, there have been reports of “phishing” attack emails using the DomainKeys technology. Moreover, if a “phishing” attacker is able to send “phishing” attack emails from the targeted domain (say a legitimate bank's domain), then neither email authentication technologies can detect and block the attack emails. Similarly, there are also “phishing” attacks that do not rely on “spoofed” emails. Instead, certain attack emails modify a file on the computer (such as a HOSTS file on a Windows PC), and once that file is modified, it sends the browser to a look-alike fraudulent web site when the user types in a legitimate URL.

Compiling a list of known fraudulent websites, and preventing visits to such web sites also has disadvantages. This approach is always handled after the fact, most likely after a number of users already fell victim to the attack, and after someone manually reports the web site as fraudulent. Moreover, it likely will not handle changes to the web site URL right away, allowing for a shifting web site to stay ahead of such a list.

Similarly, examining a web site for telltale signs of possible fraud has disadvantages. If the web site is suspicious, then the web site is blocked in the browser. However, this approach may not detect many fraudulent sites. Moreover, this approach likely requires manual examination, and thus is likely to fall behind as “phishing” web sites become more genuine in many aspects.

Accordingly, it may be useful to develop security systems and methods that can effectively safeguard online users' sensitive information, preventing the unsuspecting users from giving such information to untrustworthy third parties. Further, it may be useful for the security systems and methods to work seamlessly with the existing online systems, to preserve and enhance the user experience.

### SUMMARY

The present invention is described and illustrated in conjunction with systems, apparatuses and methods of varying scope. In addition to the aspects of the present invention described in this summary, further aspects of the invention will become apparent by reference to the drawings and by reading the detailed description that follows. A method and apparatus for authenticating destinations of sensitive data in web browsing is described and illustrated.

In an embodiment, the invention is a method. The method includes receiving website data from a website and displaying the website data. The method also includes receiving data for submission to the website, replacing data with aliases, passing only the aliases to the website. Further, the method includes receiving a request to submit the data. Moreover, the method includes recognizing the data as appropriate for protection. Additionally, the method includes authenticating the website with a set of websites related to the data. The authenticating includes determining what set of websites corresponds to the data and comparing an IP address of the website to the set of websites. Also, the method includes restoring the data from corresponding aliases when sending to the authenticated web site.

In an alternate embodiment, the invention is an apparatus. The apparatus includes a processor and a memory component coupled to the processor. The apparatus also includes a bus coupled between the processor and the memory module. Furthermore, the apparatus includes a network interface coupled to the processor. Also, the apparatus includes a browser operated by the processor and a website authentication and data recognition module coupled to the browser and operated by the processor.

In another embodiment, the invention is a method. The method includes receiving data for submission to a website, replacing data with aliases, passing only the aliases to the website. The method further includes receiving a request to submit the data. The method also includes authenticating the website with a set of websites related to the data, and restoring the data from corresponding aliases when sending the data.

### BRIEF DESCRIPTION OF THE DRAWINGS

The present invention is illustrated in various exemplary embodiments and is limited only by the appended claims.

FIG. 1 illustrates an embodiment of a “phishing” data diversion.

FIG. 2 illustrates an embodiment of a system for authenticating a destination for data sent over the web.

FIG. 3 illustrates an alternate embodiment of a system for authenticating a destination for data sent over the web.

FIG. 4A illustrates an embodiment of a server-based information repository.

FIG. 4B illustrates an embodiment of a USB FLASH-based information repository.

FIG. 4C illustrates an embodiment of a local repository.

FIG. 5 illustrates an embodiment of a method of authenticating a destination for data sent over the web.

FIG. 6A illustrates an embodiment of a web-based method of authenticating a destination for data sent over the web.

FIG. 6B illustrates an embodiment of a USB FLASH-based method of authenticating a destination for data sent over the web.

FIG. 6C illustrates an embodiment of a locally-based method of authenticating a destination for data sent over the web.

FIG. 6D illustrates an embodiment of the “single sign-on” system.

FIG. 7 illustrates an embodiment of a network which may be used with various systems and methods.

FIG. 8 illustrates an embodiment of a machine which may be used with the network of FIG. 7 and various systems and methods.

FIG. 9 illustrates an embodiment of a machine-readable medium which may be used in conjunction with a processor to execute a method.

FIG. 10 illustrates an alternate embodiment of multiple machine-readable media which may be used in conjunction with a processor to execute a method.

FIG. 11 illustrates an embodiment of a data structure which may be used with the systems and methods described herein.

### DETAILED DESCRIPTION

The present invention is described and illustrated in conjunction with systems, apparatuses and methods of varying scope. A method and apparatus for authenticating destinations of sensitive data in web browsing is described and illustrated. The invention is defined by the appended claims.

Various embodiments relate to systems and methods that detect and prevent online users from unknowingly sending sensitive information to unintended receivers or destinations over the Internet. Specifically, the systems and methods may allow each online user to specify sensitive information and their intended receivers or destinations (i.e., IP addresses), detect when any sensitive information is entered and about to be sent to a receiver not on the list of the intended receivers for the piece of sensitive information, block the transmission of the information, and alert the online user. The online user can then make explicit decisions about whether the sensitive information should be sent to the receiver or not.

In an embodiment, the invention is a method. The method includes receiving website data from a website and displaying the website data. The method also includes receiving data for submission to the website, replacing data with aliases, passing only the aliases to the website. Further, the method includes receiving a request to submit the data. Moreover, the method includes recognizing the data as appropriate for protection. Additionally, the method includes authenticating the website with a set of websites related to the data. The authenticating includes determining what set of websites corresponds to the data and comparing an IP address of the website to the set of websites. Also, the method includes restoring data from corresponding aliases when sending data to the authenticated web site.

The method may further include sending the data to the website. The method may also include determining an IP address of the website is not part of the set of websites associated with the data. The method may further include blocking data from being sent to the website. The method may also include alerting a user to blocking the data.

In some embodiments, the set of websites and associated sensitive data is maintained within a FLASH memory module with USB connectivity. In other embodiments, the set of websites and associated sensitive data is maintained in a local storage device on a machine executing the method. In other embodiments, the set of websites and associated sensitive data is maintained in a device such as PDA/cell phone with blue tooth or other connectivity. In still other embodiments, the set of websites and associated sensitive data is accessible through data requests over the world wide web to a server site.

The method may further include receiving login information from a user and logging the user into an authentication system for the authenticating. Also, the method may include receiving password information from a user corresponding to encrypted data for the user. Moreover, the method may include activating a browser which receives a website, displays the website data, receives data for submission, replacing data with aliases, passing only the aliases to the website, receives a request, recognizes the data, authenticates the website, and restoring data from corresponding aliases when sending the data.

In another embodiment, the invention is a method. The method includes receiving data for submission to a website, replacing data with aliases, passing only the aliases to the website. The method further includes receiving a request to submit the data. The method also includes authenticating the website with a set of websites related to the data. The method may also include sending the data to the website, restoring data from corresponding aliases when sending the data. The method may further include determining what set of websites corresponds to the data, and comparing an IP address of the website to the set of websites. The method may also include recognizing the data as appropriate for protection. Additionally, the method may include receiving website data from the website and displaying the website data.

Moreover, the method may include recognizing the data as potentially appropriate for protection. Additionally, the method may include prompting a user for a request to protect the data. Furthermore, the method may include registering the data as appropriate for protection. Similarly, the method may include registering an IP address of the website as a website in the set of websites associated with the data.

The method may also include determining an IP address of the website is not part of the set of websites associated with the data. The method may further include blocking data from being sent to the website. Additionally, the method may include alerting a user to blocking the data. In some embodiments, the set of websites and associated sensitive data is maintained within a FLASH memory module with USB connectivity. In other embodiments, the set of websites and associated sensitive data is maintained in a local storage device on a machine executing the method. In other embodiments, the set of websites and associated sensitive data is maintained in a device such as PDA/cell phone with blue tooth or other connectivity. In still other embodiments, the set of websites and associated sensitive data is accessible through data requests over the world wide web to a server site.

In some embodiments, the method includes activating a browser which receives data for submission, replacing data with aliases, passing only the aliases to the website, receives a request, authenticates the website, and restoring data from corresponding aliases when sending the data. In some embodiments, the method is embodied as a set of instructions in a medium, and the instructions may be executed by a processor to perform a method. This may be true for other methods of the invention as well.

In an alternate embodiment, the invention is an apparatus. The apparatus includes a processor and a memory component coupled to the processor. The apparatus also includes a bus coupled between the processor and the memory module. Furthermore, the apparatus includes a network interface coupled to the processor. Also, the apparatus includes a browser operated by the processor and a website authentication and data recognition module coupled to the browser and operated by the processor.

The apparatus may also include a USB interface coupled to the processor. The apparatus may have a FLASH memory module coupled to the USB interface and embodying a set of websites and associated sensitive data therein. Moreover, the FLASH memory device may be password-protected. Similarly, the apparatus may include means for storing data portably and means for communicating between the processor and the means for storing data portably.

The apparatus may include a local storage device coupled to the processor, the local storage device embodying a set of websites and associated sensitive data therein. Moreover, the local storage device may be encrypted.

In an alternate embodiment, the invention is an apparatus. The apparatus includes a processor and a memory component coupled to the processor. The apparatus also includes a bus coupled between the processor and the memory module. Furthermore, the apparatus includes a network interface coupled to the processor. Also, the apparatus includes a browser operated by the processor.

The apparatus may also include a second processor and memory component coupled to the second processor. The first processor may interact with the second processor through a protocol such as bluetooth. Also, the apparatus includes a website authentication and data recognition module operated by the second processor. The apparatus may also include a USB interface coupled to the second processor. The apparatus may have a FLASH memory module coupled to the USB interface and embodying a set of websites and associated sensitive data therein. Moreover, the FLASH memory device may be password-protected. Similarly, the apparatus may include means for storing data portably and means for communicating between the second processor and the means for storing data portably.

The apparatus may include a local storage device coupled to the second processor. The local storage device embodies a set of websites and associated sensitive data therein. Moreover, the local storage device may be encrypted.

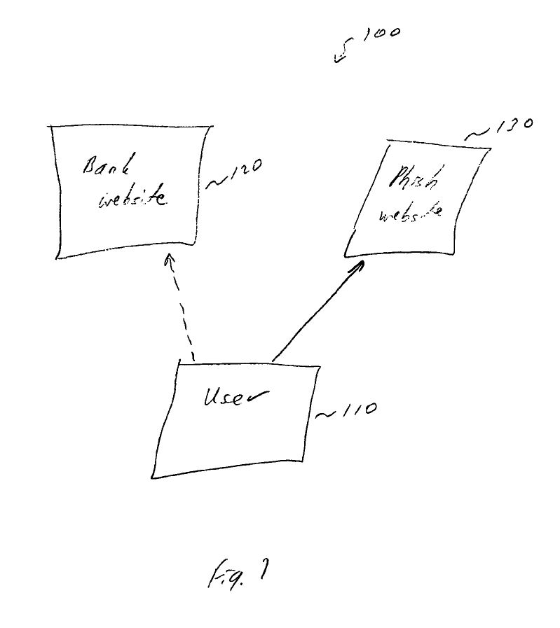

An examination of the problem of “phishing” may be useful. FIG. 1 illustrates an embodiment of a “phishing” data diversion. When a “phishing” diversion occurs, or some other fraudulent diversion of data occurs, it typically involves a user thinking that a website is a well-known vendor website, rather than a counterfeit website. Network 100 includes a user web access device 110 (e.g. a computer) which may be pointed at various URLs for web-surfing purposes. A user intends to surf at bank website 120, at a URL previously used by the user. The user follows a link to a website, and thinks website 120 is being displayed.

However, this link may have arrived in a fraudulent email, for example, sent from a “phishing” source. The link actually points the user to “phish” website 130, which mimics website 120 at some level. When the user enters personal data, such as login data for example, that data is captured in the “phishing” scheme, allowing for access by others with access to the data. From this, a user's bank account may be drained of finds, for example. Moreover, the website 130 may function as a pass through to website 120, actually logging the user in, for example, but also capturing the user's personal data in the process.

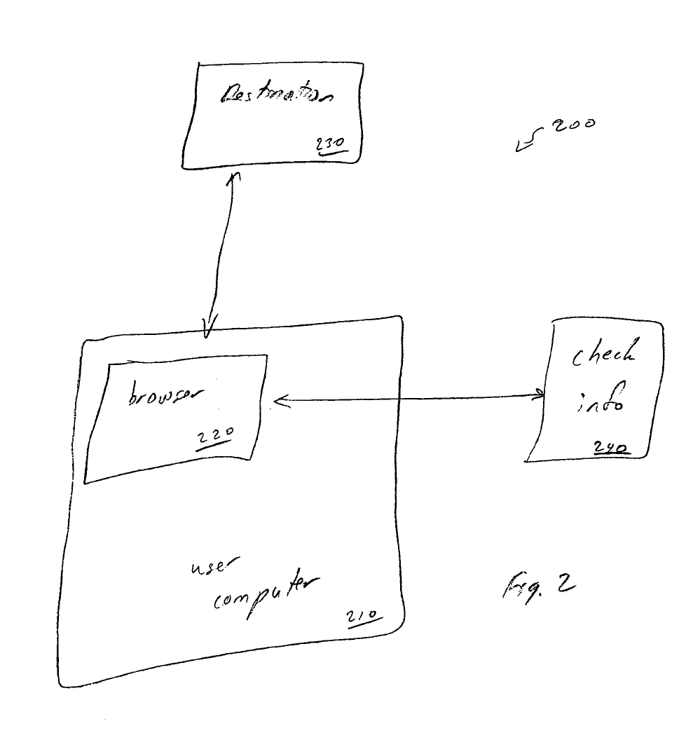

Thus, preventing the problem of sending data to the wrong URL or destination is potentially useful. FIG. 2 illustrates an embodiment of a system for authenticating a destination for data sent over the web. System 200 includes a computer with a browser on it, a destination website, and a check information database. Thus, system 200 may be used to determine whether data submitted over the web is being sent to a proper destination.

User computer 210 may be a web access device of various forms, such as a personal computer, personal digital assistant, cellular telephone, or other web-access device. Browser 220 operates on user computer 210 to interface with the web and provide a display of web-related information. This may include login screens, for example. Destination website 230 is a website found at a URL pointed to by browser 220. A user of computer 210 may attempt to submit personal data through browser 220 to destination 230. Preferably, check information repository 240 is then consulted to determine if destination 230 is a proper destination for such information. This may occur, for example, by matching specific personal information (such as a login id, for example) against a list of personal information and corresponding websites in check information repository 240, for example. If the destination 230 is proper, the data is submitted. If not, the data is blocked (not transmitted), and the user may be alerted to the situation.

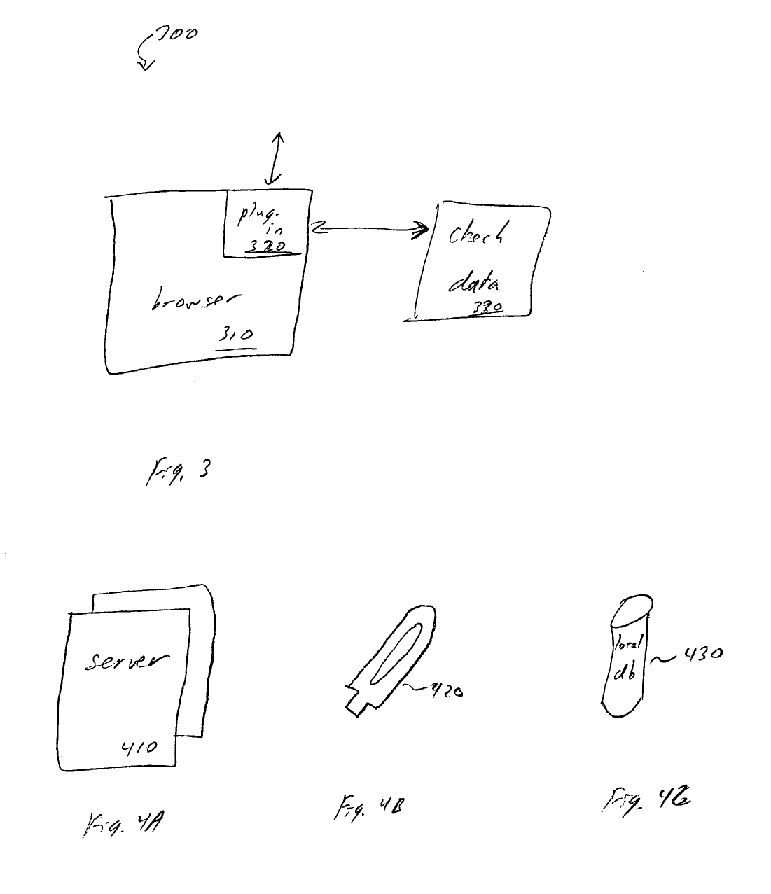

FIG. 3 illustrates an alternate embodiment of a system for authenticating a destination for data sent over the web. The destination authenticated will typically be the IP address to which the data is being sent, and may be a website associated with that IP address as well. System 300 includes a browser with an authentication add-on and a repository, which may be checked to authenticate destination websites. Thus, browser 310 may be a conventional browser. Add-on 320 may be an authentication add-on, which intercepts data submitted to websites and determines if the data should be transmitted. Check data repository 330 is a data repository including information about personal or confidential data and websites, which are acceptable destinations for such data.

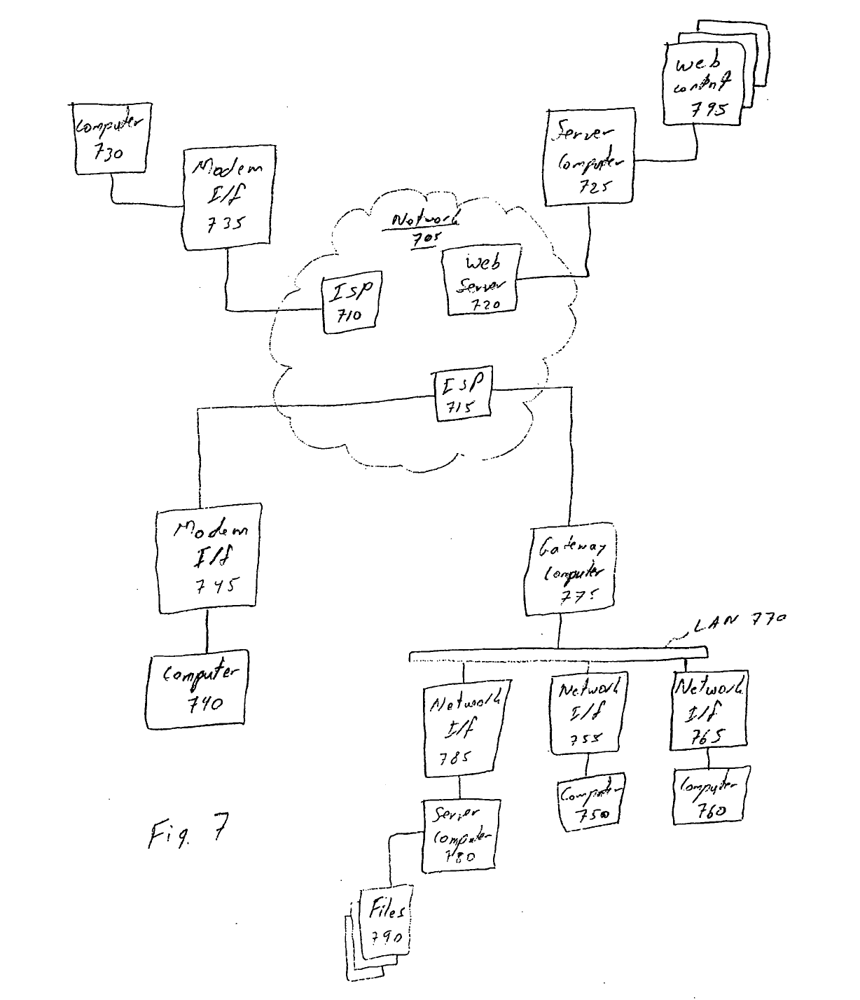

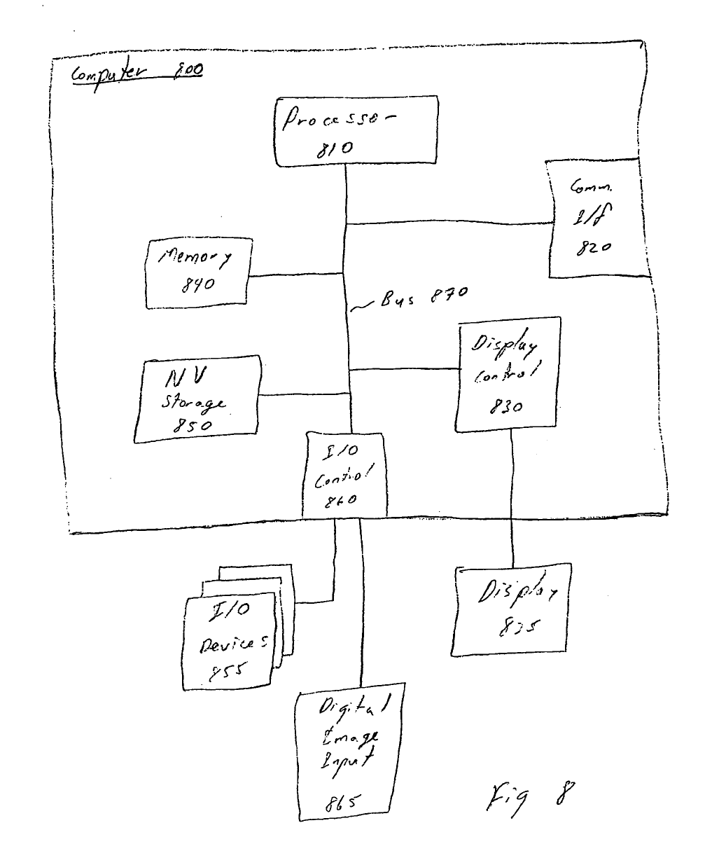

Thus, add-on 320 may check a user identifier or password in check data repository 330 to determine if browser 310 should transmit such data to a specific web site. Browser 310 may be used in conjunction with various devices, such as a computer, cellular telephone, personal digital assistant (PDA), tablet PC, web-surfing appliance, or other similar device. Examples of such devices are further discussed with respect to FIGS. 7 and 8 below.

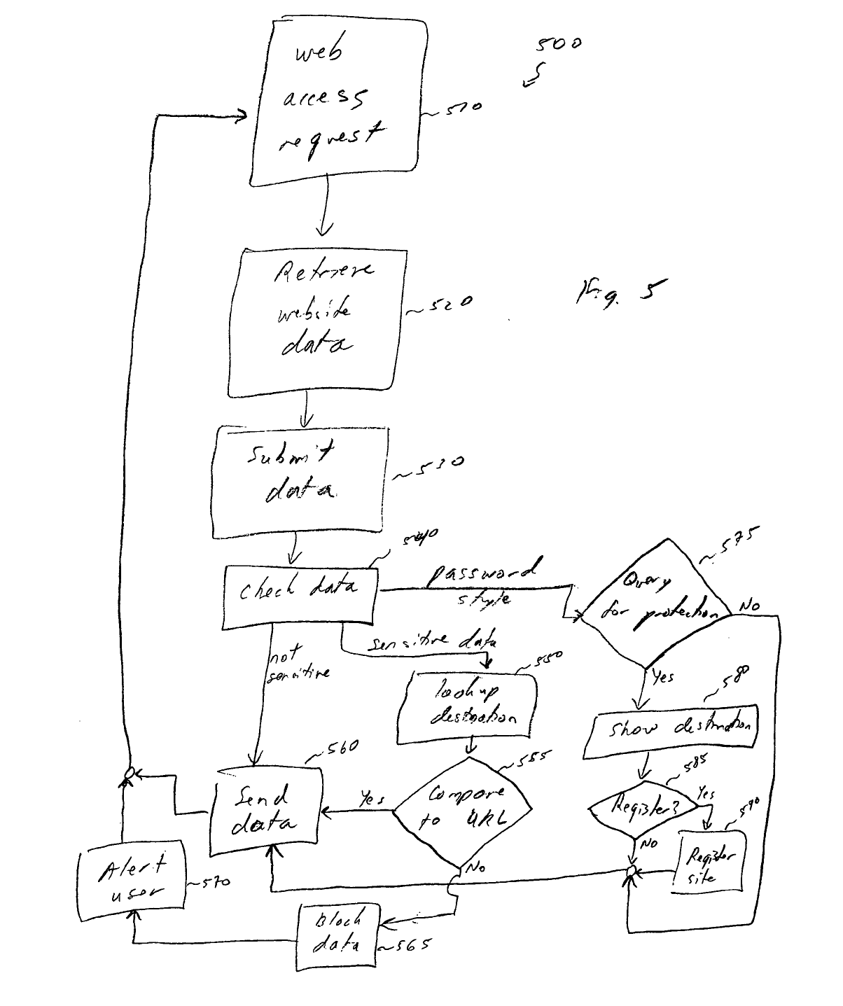

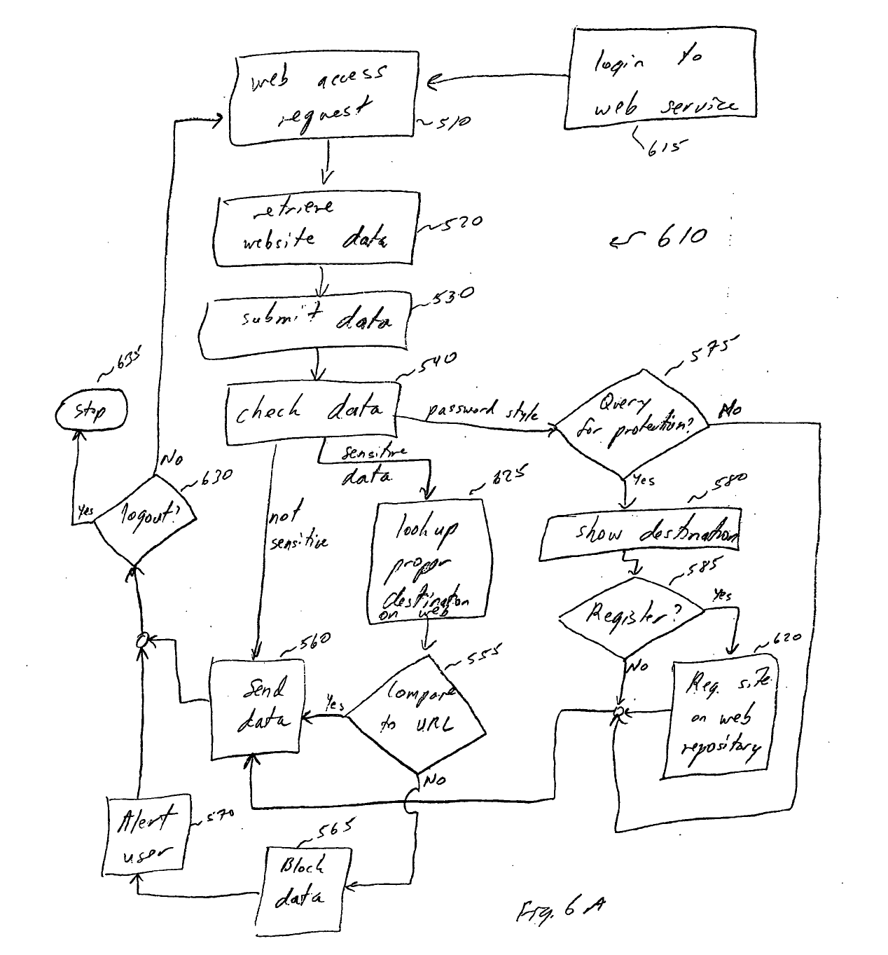

Various implementations of a repository may be used. FIG. 4A illustrates an embodiment of a server-based information repository. Server(s) 410 are web-based servers, which have access to information about personal data and appropriate websites for various users. When using a web-based system, a user may access the system from a browser on the web, and the check data repository used by the browser will be accessed through server 410.

The check data repository may also be implemented without using web access. FIG. 4B illustrates an embodiment of a USB FLASH-based information repository. USB FLASH memory is becoming widely used, and may typically be plugged into a computer or similar device, allowing for immediate access to its contents. Similar devices may use Firewire, serial or parallel ports, or other physical connectivity and bus protocols. A repository of personal data and associated websites may then be maintained on USB FLASH memory 420, allowing for authentication of websites when a browser add-on accesses the data stored in memory 420. Similarly, if a dedicated personal computer is used, a local repository may be useful. FIG. 4C illustrates an embodiment of a local repository. Local repository 430 is a local database or similar data storage structure with personal information and associated web sites therein. Similarly to the FLASH memory 420, the local repository 430 may be accessed by a browser without resorting to web access. However, local repository 430 may be not portable in the same manner as FLASH memory 420. Similar to the USB FLASH-based repository, a check data repository may be based on smart portable devices (such as PDA, smart cell phone). A repository of personal data and associated web sites may then be maintained by the smart device 440, allowing for authentication of web sites when a browser add-on accesses the data stored in it through protocols such as bluetooth. Thus, to consider the embodiment of FIG. 3, for example, check data repository 330 may be implemented as one (or more) of server 410, USB FLASH memory 420, local repository 430 or smart portable device, in various embodiments.

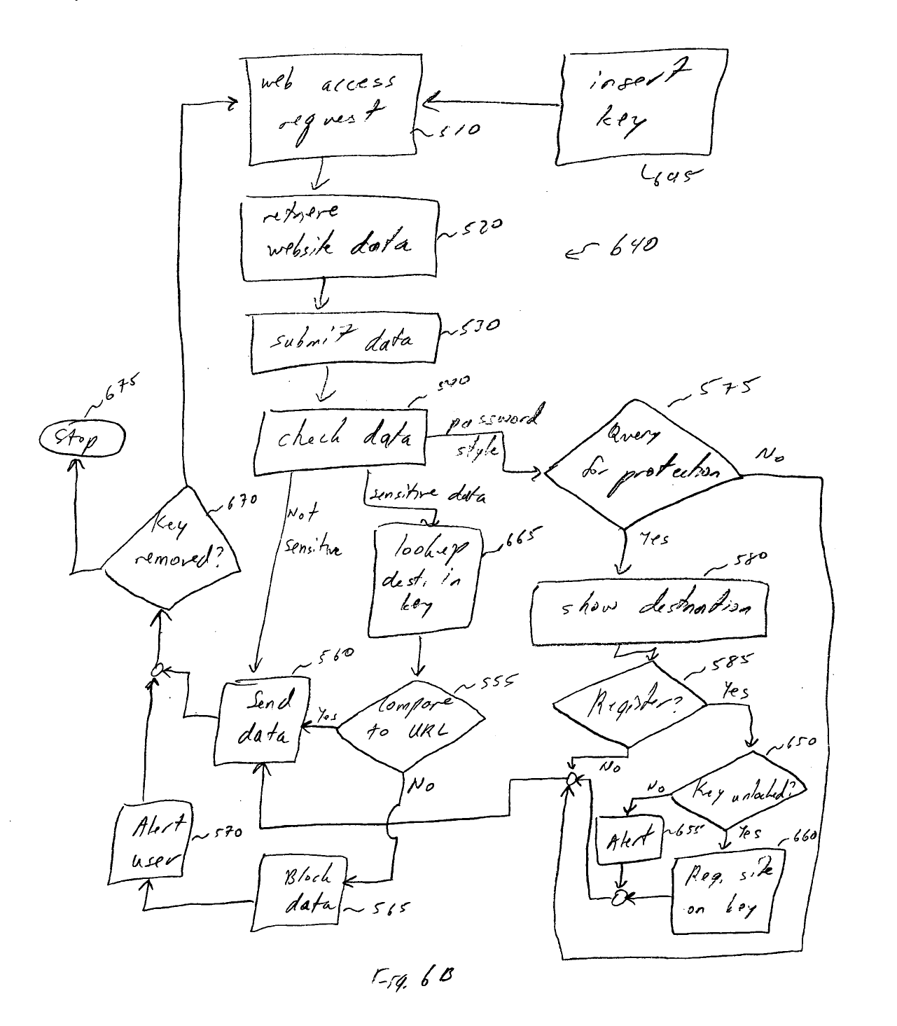

Just as various systems may be used, various methods or processes may be employed. FIG. 5 illustrates an embodiment of a method of authenticating a destination for data sent over the web. Process 500 and other processes of this document are implemented as a set of modules, which may be process modules or operations, software modules with associated functions or effects, or hardware modules designed to fulfill the process operations, for example. The modules of process 500 may be rearranged, such as in a parallel or serial fashion, and may be reordered, combined, or subdivided in various embodiments.

Process 500 includes requesting a web page, retrieving the data, intercepting partial user input data, matching the partial user input data against the sensitive information from the check data repository (such as one in FIG. 4B, for example). If a defined match is found (partial user input=“xyz”, and a password from the check data repository=“xyz123#@,” for example), user is offered the option to complete the input by selecting from the sensitive data from the check data repository or continuing to type in the rest of the input. The process further includes replacing the user input data with aliases, passing only the aliases to the web page, thus preventing active content on the page (such as JavaScript on the page) from sending out the data without explicit submission action from user, before submitting data to a web site. The process also includes checking the data, if the data is recognized as sensitive, authenticating the website, if the data appears to potentially be sensitive, checking whether it should be screened for an authentic destination, and sending the data along as appropriate.

At module 510, a web access request occurs, such as when a web browser is pointed at a URL, for example. At module 520, data at the URL is retrieved through the web, and may then be rendered or displayed for a user. At module 530, the partial user input data is intercepted and matched against the sensitive information from the check data repository, if a defined match is found (such as partial user input=“xyz”, and a password from the check data repository=“xyz123#@”, for example). The user is offered the option to complete the input by selecting from the sensitive data from the check data repository or continuing to type in the rest of the input. Then user input data is replaced with aliases, passing only the aliases to the web page, and data (aliases) is submitted for transmission to a web site. The data is checked at module 540, with at least three potential outcomes. The data may be recognized as sensitive data (a known login or password for example), it may be identified as having a format like sensitive data, or it may appear to not be sensitive.

If the data is recognized as sensitive, at module 550, the approved destination(s) of the data is retrieved from a repository based on the sensitive data detected (e.g. a password may be indexed against a web site IP address or a set of web site(s) addresses, for example). At module 555, the IP address the browser is attempting to send the data to is then compared to the approved IP addresses (for example) found in module 550. If the IP Address is approved, at module 560, the data is restored from corresponding aliases and sent to the URL as submitted. If the IP address is not approved, at module 565 the data is blocked from transmission. Additionally, at module 570, the user may be alerted to the block, such as through a message warning of “phishing” for example.

Note that additional operations may be performed when data is recognized, and recognition may occur prior to an attempt to submit data. For example, recognition may occur when user input is intercepted and compared to known sensitive user data, with a positive comparison prompting an alert, for example. Thus, keystroke capture of data may result in a comparison and recognition. However, recognition may also occur due to recognition of the website where data is being sent, recognition of the fields to which data is being provided (an examination of HTML fields or attributes for example), or due to explicit requests from the user to provide sensitive information from the authentication system.

Moreover, once sensitive data is recognized, the user may be offered the option of automatically filling in the data in the form, such as based on field names of the form and corresponding tags or attributes for user data, for example. Thus, with a username and password recognized, physical address or billing information may be automatically filled in, for example. The authentication system may provide features such as allowing the user to request that sensitive data be provided (e.g. by pressing a button on a user interface), thereby easing the burden on the user to remember such sensitive information.

If the data is recognized as similar to a piece of sensitive data such as a password (such as in format for example) or responsive to a request for a piece of sensitive data such as a password (such as through reference to field names of a webpage for example), but not an already registered piece of sensitive data, the process moves to module 575, where the user is queried as to whether the data is sensitive and thus in need of protection. The user may have passwords or logins which are only used for innocuous access (e.g. to a newspaper website for example), and thus not in need of protection. If protection is not requested by the user, at module 560 the data is sent along. At module 575, data may be recognized in other manners too, such as by examining data entered for telltale forms (e.g. 9 digits for a social security number or 16 digits for a credit card number for example), or formats (e.g. 3-2-4 patterns of digits for social security numbers, 3-3-4 patterns of digits for phone numbers, 4 sets of 4 digits for credit card numbers, for example).

If protection is requested by the user, at module 580 the potential website destination is shown to the user. If the user then wishes to register the data with the website, this is manifested at module 585, and the site is registered to the data (such as through an entry in a repository for example) at module 590. Regardless, the data is then sent to the site at module 560 (though some embodiments may allow for cancellation of data submission).

If the data is simply not sensitive, the data is sent at module 560. From module 560, the process then returns to module 510 for another web access request (such as one generated when data was sent at module 560). If data was blocked at module 565, the process also returns to module 510 for the next web access.

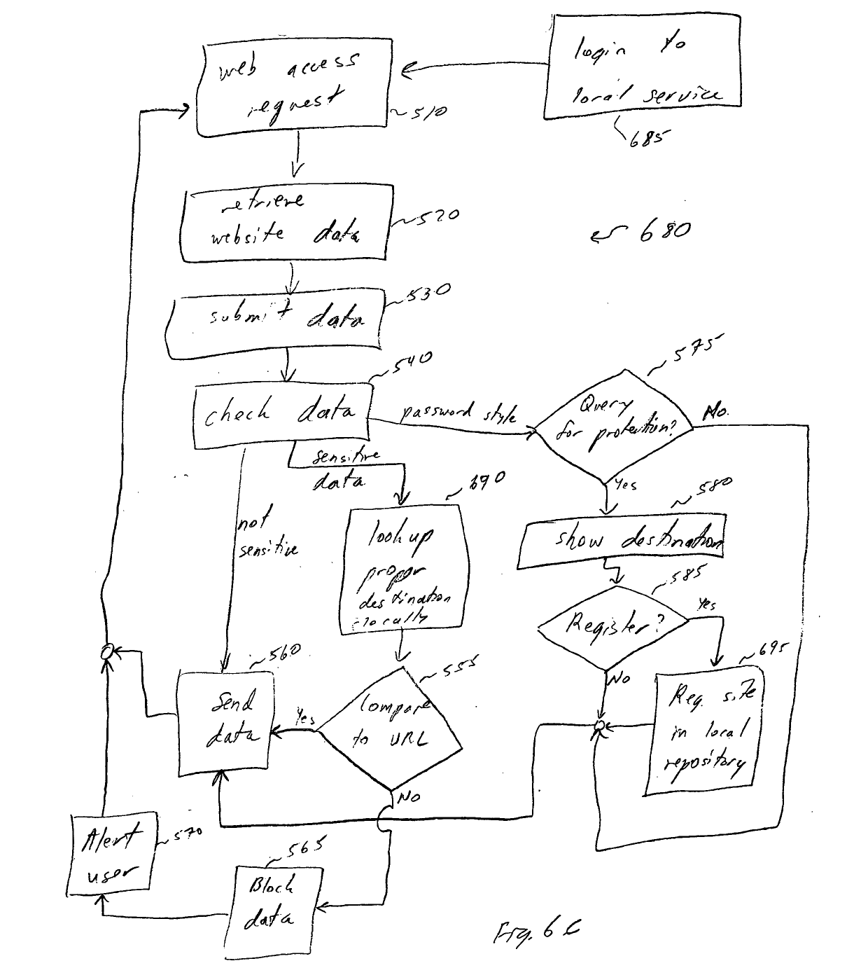

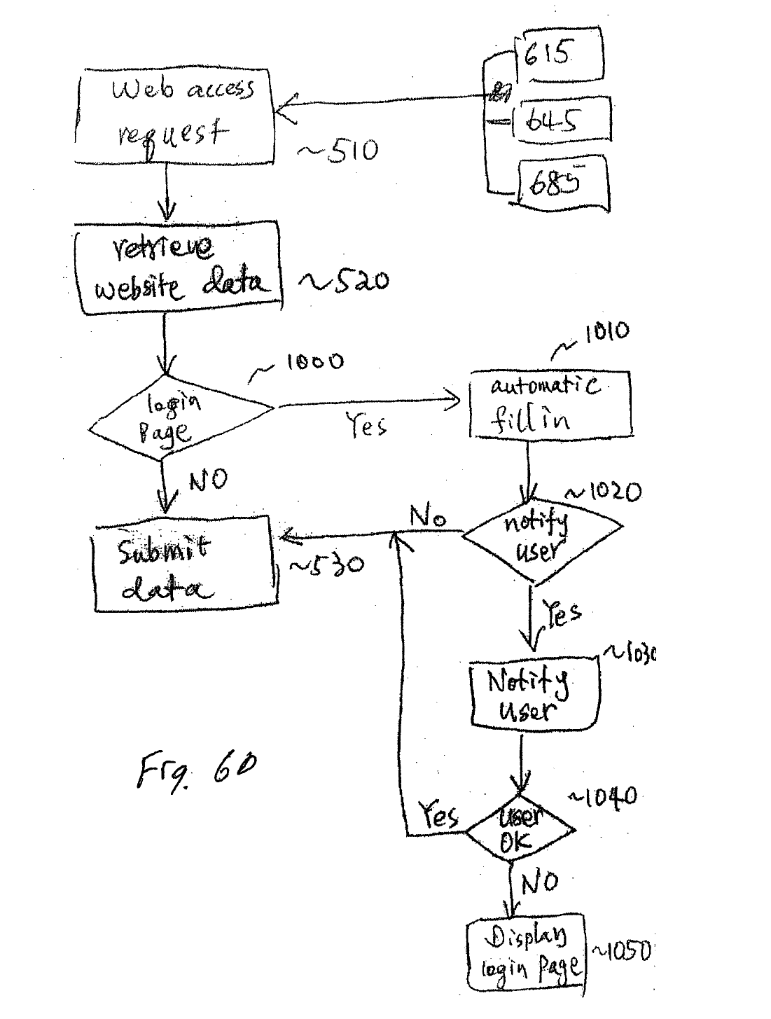

FIG. 6A illustrates an embodiment of a web-based method of authenticating a destination for data sent over the web. System 610 is a system specific to web-based access to a repository of authentication information, and is based on system 500 of FIG. 5. The differences are at modules 615, 620, 625, 630 and 635. At module 615, the user logs in to the authentication service, and may have an add-on or similar executable module installed for the browsing session. Preferably, the login process involves the specific IP address of the web services directly, or goes through the add-on, to avoid “phishing” attacks itself. The add-on may be pointed to a web site where authentication information may be accessed, and the login may effectively authenticate the user to allow for access to personal data. Note that the sensitive data may be read from the web site in advance (e.g. copying to local storage for a session) in some embodiments.

For sensitive data that is detected, the comparison information for the actual sensitive data and the appropriate destinations are found at module 625 through a web-based repository as may be accessed through a server, for example. Similarly, if a new personal data or destination website is to be registered at module 620, this occurs through the web-based registry. Moreover, if the user logs out, this is detected at module 630, allowing the web browsing session to terminate at module 635. Alternatively, the authentication functions may be ended at module 635, without otherwise affecting the web browsing session.

As a web-based session may be useful in some circumstances, a locally-based session on a remote computer may also be useful. FIG. 6B illustrates an embodiment of a USB FLASH-based method of authenticating a destination for data sent over the web. System 640 is specific to a USB FLASH or similar portable key, and differs from process 500 at modules 645, 650, 655, 660, 665, 670 and 675.

To initiate an authenticated web-browsing session, a key is inserted into a USB port or similar physical interface at module 645. Possession of the key authenticates the user as able to access the data of the key in some embodiments. In other embodiments, further authentication such as entry of a password for the key is required. This also occurs at module 645 in some such embodiments. Sensitive data is accessed from the key at module 665, and similarly appropriate destination IP addresses are accessed from the key at module 665, too. Note that the sensitive data may be read from the key in advance (e.g. copying to local storage for a session) in some embodiments.

When a new site or personal data is to be registered, this occurs at module 650, where a check is made as to whether the key is unlocked (writing is permitted). If so, the site or data is registered on the key at module 660 and will be available for later access. If not, at module 655 an alert is provided to the user, and an option to unlock the key may be provided in some embodiments.

When the key is removed, this is detected at module 670. If the key is not removed, authenticated surfing may continue at module 510. If the key is removed, at module 675 the process or the authenticated surfing process may stop. Thus, the key may function as a browsing interlock—browsing only occurs with it plugged in, or as an authentication key only.

In some instances, a local repository on a dedicated personal computer (e.g. an office computer or a home computer) may be used. FIG. 6C illustrates an embodiment of a locally-based method of authenticating a destination for data sent over the web. System 680 is specific to a local repository. It differs from process 500 at modules 685, 690 and 695.

When proper destinations or sensitive data is looked up, this occurs at module 690, through use of a local database. Similarly, when a site or personal datum is registered, this occurs at module 695 through a local repository. Typically, this may be enabled through a login procedure verifying at module 685 that the user of the system should be able to access the local repository prior to initial web browsing.

Another option for implementation may be referred to as a “single sign-on” system. FIG. 6D shows an embodiment of the “single sign-on” system. A user can have multiple accounts at multiple web sites (for example, a user may have an online account with his bank, an online account with his brokerage firm, and an online account with eBay). The user has individual and preferably different login and passwords for each of his online account for security reasons. If the user needs to perform some activity with a bank account, the user explicitly logs in to the bank account online. If, during the process of activity at the bank, the user also needs to perform some activity with a brokerage account, the user also logs in to an online account at the brokerage web site.

“Single sign-on” refers to the capability for the user to perform login once (possibly to a separate entity), and be able to work in all online accounts without having to do explicit login processes separately. Note that all accounts would typically include only accounts registered for the “single sign-on” service. “Single sign-on” may provide the advantage of not requiring a user to remember and manage multiple login/passwords for separate accounts.

As FIG. 6D shows, a user performs a login once (either through module 615, 645, or 685), and then attempts to access a web page at module 510. Since the user has not logged in to the web site (the bank site for example), the site returns a login page to the browser at module 520. At module 1000 it is determined that the page is a login page requiring login Id and password, and module 1010 retrieves the user's login Id and password from the repository for the site (login Id and password may be indexed against a web site IP address or a set of web site(s) addresses, for example) and automatically fills in the input fields.

If module 1020 determines that the user should be notified (by checking the user settings for example), then the user is notified at module 1030. Data is then submitted at module 530 if the user consents at module 1040. If the user did not want notification or notification was determined not to be appropriate, the data is simply submitted at module 530 without user notification. If the user does not want automatic login to the web site (based on the determination at module 1040), the login page from the web site is displayed at module 1050 for user input/navigation.

While the above “single sign-on” embodiment differs from the a traditional “single sign-on”, it does provide the convenience of a traditional “single sign-on” to end users, and in the meantime, it allows the existing web sites to retain control of the login relationship with their users. The existing web sites do not have to switch and trust a third party to certify that a user is genuine. It is also potentially scalable, since no third party is involved, and thus, potentially avoids a single point of failure. Moreover, the process of FIG. 6D may operate in conjunction with a process such as that of FIG. 6A for purposes of recognizing what data should be protected and registered, for example.

The following description of FIGS. 7-8 is intended to provide an overview of computer hardware and other operating components suitable for performing the methods of the invention described above and hereafter, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the Internet. The term “Internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the Internet and the protocols and communication procedures of the Internet are well known to those of skill in the art.

Access to the Internet 705 is typically provided by Internet Service Providers (ISP), such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the world wide web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, a tablet PC, a personal digital assistant, a two-way pager, a cellular telephone, a web tv system, or other such computer system.

Similarly, the ISP 715 provides Internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 8 shows one example of a conventional computer system that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel Pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well-known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

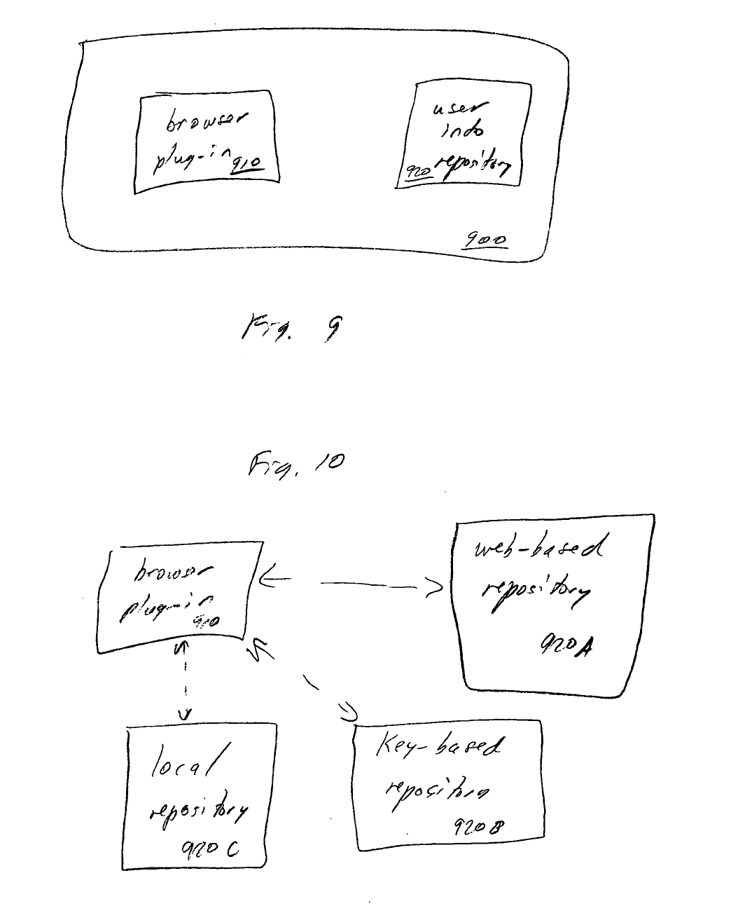

Typically, a computer or similar device may be used in conjunction with machine-readable media to execute a process or method. FIG. 9 illustrates an embodiment of a machine-readable medium which may be used in conjunction with a processor to execute a method. Medium 900 represents a machine-readable medium or set of media, such as the types of media described above. Typically, a medium embodies instructions which can be executed by the processor of a device, and the processor executes a method or process responsive to the instructions, in conjunction with other parts of the device or computer.

Medium 900 includes a browser add-on 910 and a user information repository 920. When operating, browser add-on 910 accesses user information repository 920 to obtain information about websites (e.g. IP addresses) and about confidential or sensitive user information. As illustrated, a single medium incorporates the add-on 910 and the repository 920, allowing for portability and security.

FIG. 10 illustrates an alternate embodiment of multiple machine-readable media which may be used in conjunction with a processor to execute a method. As illustrated in FIG. 10, the location of the repository may vary depending on implementation details. For example, a web-based repository 920A may be accessed through the world wide web, allowing for access at a terminal to the repository without requiring access to the terminal to store the repository on the terminal. Alternatively, a key-based repository 920B may be used. Repository 920B may be a memory module which is accessible through a port on a terminal or PC, thus allowing for individual control of the repository and transportation of the repository. Repository 920C provides a local storage repository, which may be tied to a specific machine and accessible only at that machine. Rather than providing transportability, this provides security from external intrusion and convenience of not needing to plug in a module.

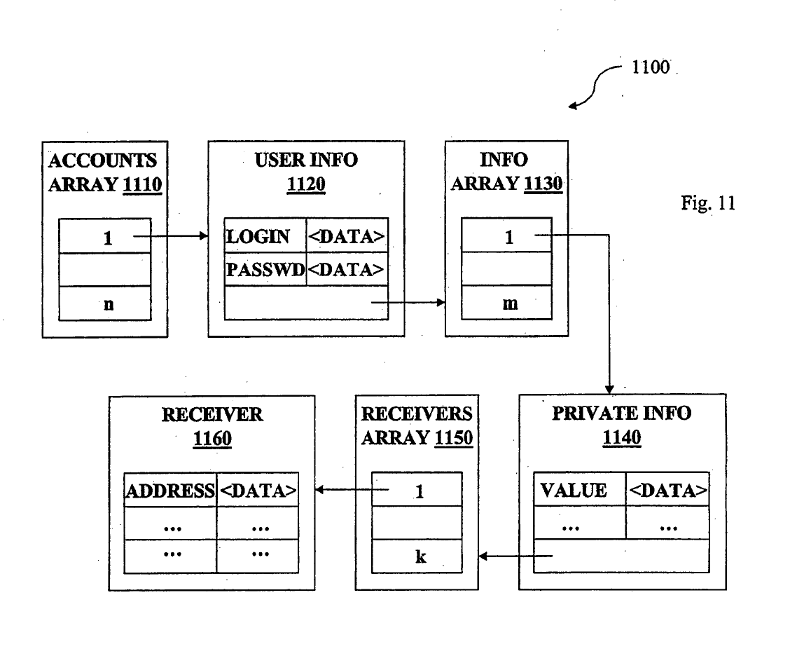

Along with various media, various data structures may be used. FIG. 11 illustrates an embodiment of a data structure which may be used with the systems and methods described herein. Data structure 1100 includes an account array, a user information structure, an information array, a private information structure, a receiver array, and a receiver information structure. Data structure 1100 may be implemented in a variety of ways, such as through databases or linked lists, for example.

Account array 1110 is illustrated as an array of account information, with pointers into user information structures 1120. A user information structure is illustrated as including a set of fields, such as user identification, password, and other similar information about a user. Typically, a user must provide the identification and password of structure 1120 to use the associated authentication system.

Information array 1130 includes entries for information for a user, potentially corresponding to different websites, or potentially useful with a variety of websites. Private information structure 1140 includes additional private information for the user, information which should be safeguarded and for which authentication of the receiving website is to be provided. Receivers array 1150 includes a set of potential receivers of the user information, particularly private information, which are allowed to receive the information. Receiver structure 1160 is exemplary of structures for particular receivers, including an address (e.g. a URL or other website address) and an IP address (the actual dotted quad set of numbers used to find the receiver). Thus, private data will have a corresponding set of receivers, and those receivers will each have a set of IP addresses (one or more). The system will preferably verify that the receiver is actually at an authorized IP address. Moreover, the IP addresses may be obtained from domain servers based on registry information for domains, providing an independent check of IP addresses.

From the foregoing, it will be appreciated that specific embodiments of the invention have been described herein for purposes of illustration, but that various modifications may be made without deviating from the invention. In some instances, reference has been made to characteristics likely to be present in various or some embodiments, but these characteristics are also not necessarily limiting on the invention. In the illustrations and description, structures have been provided which may be formed or assembled in other ways within the invention.

In particular, the separate modules of the various block diagrams represent functional modules of methods or apparatuses and are not necessarily indicative of physical or logical separations or of an order of operation inherent in the present invention. Similarly, methods have been illustrated and described as linear processes, but such methods may have operations reordered or implemented in parallel within the invention. Accordingly, the invention is not limited except as by the appended claims.

What is claimed is:

1. An apparatus, comprising:
a processor;
a memory component coupled to the processor;
a bus coupled between the processor and the memory module;
a network interface coupled to the processor;
a browser operated by the processor; and
a website authentication and data recognition module coupled to the browser and operated by the processor.

2. The apparatus of claim 1, further comprising:
a USB interface coupled to the processor; and
a FLASH memory module coupled to the USB interface and embodying a set of websites and associated sensitive data therein.

3. The apparatus of claim 2, wherein:
the FLASH memory device is password-protected.

4. The apparatus of claim 1, further comprising:
means for storing data portably; and
means for communicating between the processor and the means for storing data portably.

5. The apparatus of claim 1, further comprising:
a local storage device coupled to the processor, the local storage device embodying a set of websites and associated sensitive data therein.

6. The apparatus of claim 5, wherein:
the local storage device is encrypted.

7. The apparatus of claim 1, further comprising:
a module to obtain a set of websites and associated sensitive data from a web-based repository.

8. A machine-readable medium embodying instructions which, when executed by a processor, cause the processor to perform a method, the method comprising:
receiving website data from a website;
displaying the website data;
receiving data for submission to a website;
intercepting data;
replacing data with aliases;
passing only the aliases to the web page;
receiving a request to submit the data;
recognizing the data as appropriate for protection; and
authenticating the website with a set of websites related to the data.

9. The machine-readable medium of claim 8, wherein the method further comprises:
restoring data from corresponding aliases; and
sending the data to the website.

10. The machine-readable medium of claim 8, wherein:
authenticating the website includes:
determining what set of websites corresponds to the data; and
comparing an IP address of the website to the set of websites.

11. The machine-readable medium of claim 8, wherein the method further comprises:
prompting a user for a request to protect the data;
registering the data as appropriate for protection; and
registering an IP address of the website as a website in the set of websites associated with the data.

12. The machine-readable medium of claim 8, wherein the method further comprises:
registering multiple IP addresses of the website in the set of websites associated with the data.

13. The machine-readable medium of claim 8, wherein the method further comprises:
determining an IP address of the website is not part of the set of websites associated with the data;
blocking data from being sent to the website; and
alerting a user to blocking the data.

14. A method, comprising:
receiving website data from a website;
displaying the website data;
receiving data for submission to the website;
intercepting data;
replacing data with aliases;
passing only the aliases to the web page;
receiving a request to submit the data;
recognizing the data as appropriate for protection; and
authenticating the website with a set of websites related to the data, including determining what set of websites corresponds to the data and comparing an IP address of the website to the set of websites.

15. The method of claim 14, further comprising:
restoring data from corresponding aliases; and
sending the data to the website.

16. The method of claim 14, further comprising:
determining an IP address of the website is not part of the set of websites associated with the data.

17. The method of claim 16, further comprising:
blocking data from being sent to the website.

18. The method of claim 17, further comprising:
alerting a user to blocking the data.

19. The method of claim 14, wherein:
the set of websites and associated sensitive data is maintained within a FLASH memory module with USB connectivity.

20. The method of claim 14, wherein:
the set of websites and associated sensitive data is maintained in a local storage device on a machine executing the method.

21. The method of claim 14, wherein:
the set of websites and associated sensitive data is accessible through data requests over the world wide web to a server site.

22. The method of claim 14, further comprising:
receiving login information from a user; and
logging the user into an authentication system for the authenticating.

23. The machine-readable medium of claim 8, wherein:
the set of websites and associated sensitive data is maintained within a FLASH memory module with USB connectivity.

24. The machine-readable medium of claim 8, wherein:
the set of websites and associated sensitive data is maintained in a local storage device on a machine executing the method.

25. The machine-readable medium of claim 8, wherein:
the set of websites and associated sensitive data is accessible through data requests over the world wide web to a server site.

26. The machine-readable medium of claim 8, wherein the method further comprises:
intercepting partial user input data;
matching partial user input data against the set of web sites and associated sensitive data;
offering to the user the option to complete input by selecting from the set of web sites and associated sensitive data if a defined match is found;
replacing input data with aliases; and
passing only the aliases to the web page.
